(19) United States
(12) Patent Application Publication
(10) Pub. No.: US 2007/0286934 A1
(43) Pub. Date: Dec. 13, 2007

(54) Frozen confections and method of manufacturing same

(76) Inventor: Brian Schallhorn, Kitchener (CA)

Correspondence Address: MILLER THOMSON LLP, 100 STONE ROAD WEST, SUITE 301, GUELPH, ON, N1G-5L3, US

(21) Appl. No.: 11/808,630

(22) Filed: Jun. 12, 2007

Related U.S. Application Data
(60) Provisional application No. 60/812,630, filed on Jun. 12, 2006.

(51) Int. Cl. A23G 9/00

(52) U.S. Cl. 426/565

(57) ABSTRACT

A frozen confection having improved nutritional value namely improved protein, omega essential fatty acids, energy and mineral and vitamin levels. An improved method of manufacture of a frozen confection that is simplified and does not require pasteurization thereby providing improved shelf life.

### FIELD OF THE INVENTION

This invention relates in general to frozen confections and more particularly to a frozen confection that is nutritious and can be manufactured in a variety of healthy flavours.

### BACKGROUND OF THE INVENTION

There is an ever increasing demand for food products that consumers consider to be healthy. This demand is especially evident in the confectionary sector where traditionally these products are full of sugar and additives resulting in a confection that has low nutritional value. In the frozen confectionary sector, traditionally the frozen confection can take the form of ice cream, frozen yogurt, ice milk, non-dairy frozen products like gelato and sorbet or combination products. The most popular are the products with dairy derived ingredients, typically ice cream and non-dairy products such as frozen ices or products based on frozen fruit juices.

Typically the methods used to manufacture frozen confections affects the types of frozen confections being produced. Frozen confections are typically prepared at a factory site using raw material that is then mixed with a liquid ingredient such as milk or cream. Frozen fruit mixes are typically supplied in a pureed form. All of these mixes have very limited shelf life and must be used within a relatively short prescribed time. In addition, all dairy products and fruit pureed ingredient mixes must be pasteurized in the factory to kill any bacteria that may have grown during shipment and storage of the mix. As such there is not only a need for a frozen confection having improved nutritional value and improved shelf stability, but also a need for an improved manufacturing process.

Prior art frozen confections have been devised to address the noted issues. For example, U.S. Pat. No. 6,395,314 issued on May 28, 2002 to Whalen et al. This patent relates to a process for forming a syrup product that is suitable for use as a non-dairy frozen confection. The non-dairy frozen confection exhibits selected sweetness, texture, and mouth feel characteristics while being devoid of exogenous sweeteners, stabilizers, emulsifiers, and proteins. The process includes blending a base formulation and water to form a slurry, the base formulation having a major amount of an oat material or waxy barley hybrid flour. The process also includes liquefying and saccharifying the slurry to produce the syrup product.

U.S. Pat. No. 5,989,598 and U.S. Pat. No. 5,723,162 which issued on Nov. 13, 1999 and Mar. 3, 1998 respectively to Whalen et al. relate to a process for forming a non-dairy frozen confection from an oat material or barley material. The non-dairy frozen confection exhibits selected sweetness, texture, and mouth feel characteristics while being devoid of exogenous sweeteners, stabilizers, emulsifiers, and proteins.

Zweben is the owner of U.S. Patent Application Publication No. 2006/0029709 which was published on Feb. 9, 2006. This patent relates to a frozen confection made from masticating frozen foodstuffs and such having no air entrapment (overrun); a homogeneous consistency; an increase in total sugar content as compared to the feed material; and a superior mouth feel. This frozen confection possesses an appearance and a mouth feel similar to soft-serve ice-cream without the use of air, dairy, fillers, creaming agents, preservatives, or additives of any sort. Upon processing, the frozen convection made from frozen fruit, vegetables, or foodstuffs shows a gain in natural sugars.

However to date formulae for frozen confections have not included a set of ingredients focused exclusively on healthy additives. In general frozen confections derive most of their nutritional content from the ingredients that are used to create the desired flavours and textures. For example, ice cream and soy products derive their protein content from the dairy and soy ingredients respectively, which in turn provide the desired taste and texture to the product.

Thus a frozen confection which has improved nutritional value, improved shelf life and has an improved manufacturing process is desirable.

### SUMMARY OF THE INVENTION

An object of one aspect of the present invention is to provide an improved frozen confection having improved nutritional value and shelf stability as well as an improved method of manufacture.

In accordance with one aspect of the present invention there is provided a frozen confection that has improved nutritional value by having increased protein content made from a starting material of wet or dry flavouring and a wet or dried protein material where the wet or dried protein material is a maximum 75% of the total weight of the product

In accordance with one aspect of the present invention there is provided a frozen confection that has improved nutritional value by having increased protein content made from a starting material of wet or dried or powdered fruit and a wet or dried protein material where the dried or liquid protein material is a maximum 75% of the total weight of the product.

In accordance with another aspect of the present invention there is provided a frozen confection that has improved nutritional value by having increased omega essential fatty acids content and is made from a starting material of wet or dried flavouring and wet or dried omega essential fatty acids where the wet or dried omega essential fatty acids is a maximum 95% of the total weight of the product.

In accordance with another aspect of the present invention there is provided a frozen confection that has improved nutritional value by having increased omega essential fatty acids content and is made from a starting material of wet or dried or powdered fruit and wet or dried omega essential fatty acids where the wet or dried omega essential fatty acids is a maximum 95% of the total weight of the product.

In accordance with another aspect of the present invention there is provided a frozen confection that has improved nutritional value by having an increased value of energy rich ingredients and is made from a starting material of wet or dried flavouring and wet or dried ginseng and wet or dried guarana where the wet or dried ginseng is a maximum of 75% of the total weight of the product and the wet or dried guarana is a maximum of 75% of the total weight of the product.

In accordance with another aspect of the present invention there is provided a frozen confection that has improved nutritional value by having an increased value of energy rich ingredients and is made from a starting material of wet or dried or powdered fruit and wet or dried ginseng and wet or dried guarana where the wet or dried ginseng is a maximum of 75% of the total weight of the product and the wet or dried guarana is a maximum of 75% of the total weight of the product.

In accordance with another aspect of the present invention there is provided a frozen confection that has improved nutritional value by having an increased vitamin and mineral blend and is made from a starting material of wet or dried flavouring and wet or dried taurine where the wet or dried taurine is a maximum 75% of the total weight of the product.

In accordance with another aspect of the present invention there is provided a frozen confection that has improved nutritional value by having an increased vitamin and mineral blend and is made from a starting material of wet or dried or powdered fruit and wet or dried taurine where the wet or dried taurine is a maximum 75% of the total weight of the product.

In accordance with another aspect of the present invention there is a provided a method of manufacture of a frozen confection including blending a starting material of wet or dry flavouring and a wet or dried material that has increased nutritional value to create a dry pre-blend; reconstituting the dry pre-blend with a liquid; blending the liquid and the pre-blend creating a slurry; allowing the slurry to settle to remove air bubbles; forming the slurry into a desired format for a frozen confection; and freezing the slurry to a frozen state.

In accordance with another aspect of the present invention there is a provided a method of manufacture of a frozen confection including blending a starting material having a wet or dried or powdered fruit and a wet or dried material that has increased nutritional value to create a dry pre-blend; reconstituting the dry pre-blend with a liquid; blending the liquid and the pre-blend creating a slurry; allowing the slurry to settle to remove air bubbles; forming the slurry into a desired format for a frozen confection; and freezing the slurry to a frozen state.

Advantages of the present invention are: higher nutritional value than typical frozen confections such as ice cream or frozen juice pops, reduced manufacturing time, increased efficiency in manufacturing, no pasteurization of the frozen confection, increased shelf life, reduced costs for shipping and storage of product, reduction in production errors, and reduced possibility of contamination of product.

### DETAILED DESCRIPTION OF THE PREFERRED EMBODIMENT

The present invention will be described by way of examples wherein the percents in the description and drawings are in terms of weight:

### EXAMPLE 1

In accordance with a preferred embodiment of the present invention there is provided a frozen confection that has improved nutritional value by having increased protein content made from a starting material of wet or dried or powdered fruit and a wet or dried protein material where the wet or dried protein powder is a maximum 75% of the total weight of the product. A frozen confection was produced in accordance with Table 1. More specifically a starting material was obtained by dry mixing the ingredients in Table 1 in the indicated proportions. Upon obtaining a dry-blend of the ingredients outlined in Table 1 the ingredients are reconstituted or re-hydrated and blended to form a solution or slurry. The solution is allowed to settle to remove or reduce the number of trapped air bubbles. The waiting period may be between zero to six hours. The solution may be slightly agitated prior to its being packed into a desired mold and frozen into a solid state. Table 2 describes the ingredients of an alternative flavour for a frozen confection having increased protein content.

TABLE 1

| | Percentage | Percentage |
|---|---|---|
| | of Weight | of |
| | on total | Variance |
| Ingredient | Product | Allowable |
| Mango Protein | | |
| Citric Acid | 1.85 | 45% |
| Anhydrous | | |
| Sugar Fine | 34.7 | 25% |
| Granulated | | |
| Mango Powder | 7.89 | 85% |
| Whey Isolate | 55.52 | 75% |
| Yellow Color # 6 | 0.05 | 35% |
| | 100% | |

TABLE 2

| | | Percentage |
|---|---|---|
| | Percentage | of |
| | of | Variance |
| Ingredient | Weight | Allowable |
| Chocolate | | |
| Protein | | |
| Skim Milk | 4.41 | 25% |
| Powder (med temp) | | |
| Sugar Fine | 37.44 | 25% |
| Granulated | | |
| Cocoa Powder | 5.29 | 85% |
| Whey Isolate | 52.86 | 75% |
| | 100% | |

### EXAMPLE 2

In accordance with another aspect of the present invention there is provided a frozen confection that has improved nutritional value by having increased omega essential fatty acids content and is made from a starting material of wet or dried or powdered fruit and wet or dried omega essential fatty acids where the wet or dried omega essential fatty acids is a maximum 95% of the total weight of the product. A frozen confection was produced in accordance with Table 3. More specifically a starting material was obtained by dry mixing the ingredients in Table 3 in the indicated proportions. Upon obtaining a dry-blend of the ingredients outlined in Table 3 the ingredients are reconstituted or re-hydrated and blended to form a solution or slurry. The solution is allowed to settle to remove or reduce the number of trapped air bubbles. The waiting period may be between zero to six hours. The solution may be slightly agitated prior to its being packed into a desired mold and frozen into a solid state. Table 4 describes the ingredients of an alternative flavour for a frozen confection having increased omega essential fatty acid content.

TABLE 3

| | Percentage | Percentage |
|---|---|---|
| | of Weight | of |
| | on total | Variance |
| Ingredient | Product | Allowable |
| Choc/Banana | | |
| Omega | | |
| Skim Milk | 1.57 | 50% |
| Powder (med Temp) | | |
| Sugar Fine | 33.83 | 25% |
| Granulated | | |
| Cocoa Powder | 6.27 | 85% |
| Whey Isolate | 43.86 | 75% |
| Banana Powder | 14.1 | 85% |
| Banana Flavor | 0.38 | 85% |
| Omegas | 900 mg | 95% |

TABLE 4

| | | Percentage |
|---|---|---|
| | Percentage | of |
| | of | Variance |
| Ingredient | Weight | Allowable |
| Mango/Papaya | | |
| Sugar Fine | 31.69 | 25% |
| Granulated | | |
| Whey Isolate | 56.04 | 75% |
| Citric Acid | 0.25 | 45% |
| Anhydrous | | |
| Yellow Color # 6 | 0.04 | 35% |
| Mango Powder | 7.49 | 85% |
| Papaya Flavor | 4.49 | 85% |
| Omegas | 900 mg | 95% |

### EXAMPLE 3

In accordance with another aspect of the present invention there is provided a frozen confection that has improved nutritional value by having an increased value of energy rich ingredients and is made from a starting material of wet or dried or powdered fruit and wet or dried ginseng and wet or dried guarana where the wet or dried ginseng is a maximum of 75% of the total weight of the product and the wet or dried guarana is a maximum of 75% of the total weight of the product. A frozen confection was produced in accordance with Table 5. More specifically a starting material was obtained by dry mixing the ingredients in Table 5 in the indicated proportions. Upon obtaining a dry-blend of the ingredients outlined in Table 5 the ingredients are reconstituted or re-hydrated and blended to form a solution or slurry. The solution is allowed to settle to remove or reduce the number of trapped air bubbles. The waiting period may be between zero to six hours. The solution may be slightly agitated prior to its being packed into a desired mold and frozen into a solid state. Table 6 describes the ingredients of an alternative flavour for a frozen confection having increased energy values.

TABLE 5

| | Percentage | Percentage |
|---|---|---|
| | of Weight | of |
| | on total | Variance |
| Ingredient | Product | Allowable |
| Raspberry/Strawberry | | |
| Energy | | |
| Guar Gum | 0.06 | 75% |
| Carrageenan Premium | 0.08 | 75% |
| Xanthum Gum | 0.08 | 75% |
| Sugar Fine Granulated | 75.61 | 25% |
| Citric Acid Anhydrous | 0.76 | 45% |
| Ginsing 2% | 0.15 | 75% |
| Guarana 22% | 0.26 | 75% |
| Strawberry Powder | 8.39 | 85% |
| Strawberry Flavor | 0.57 | 85% |
| Raspberry Powder | 6.99 | 85% |
| Raspberry Flavor | 0.38 | 85% |
| Vanilla Flavor | 0.30 | 85% |
| (artificial) | | |
| Allura/Red 40 Dye | 0.04 | 35% |

TABLE 6

| Pineapple/Tangerine | | |
|---|---|---|
| Energy | | |
| Guar Gum | 0.08 | 75% |
| Carrageenan | 0.08 | 75% |
| Premium | | |
| Xanthum Gum | 0.08 | 75% |
| Sugar Fine | 79.67 | 25% |
| Granulated | | |
| Citric Acid | 1.60 | 45% |
| Anhydrous | | |
| Ginsing 2% | 0.16 | 75% |
| Guarana 22% | 0.28 | 75% |
| Tangerine | 0.20 | 85% |
| 4056-N Tangerine | 3.79 | 85% |
| 4052-N Pineapple | 5.95 | 85% |
| Pineapple Flavor | 1.20 | 85% |
| (artificial) | | |
| Color Yellow # 5 | 0.04 | 35% |

### EXAMPLE 4

In accordance with another aspect of the present invention there is provided a frozen confection that has improved nutritional value by having an increased vitamin and mineral blend and is made from a starting material of wet or dried or powdered fruit and wet or dried taurine where the wet or dried taurine is a maximum 75% of the total weight of the product. A frozen confection was produced in accordance with Table 7. More specifically a starting material was obtained by dry mixing the ingredients in Table 7 in the indicated proportions. Upon obtaining a dry-blend of the ingredients outlined in Table 7 the ingredients are reconstituted or re-hydrated and blended to form a solution or slurry. The solution is allowed to settle to remove or reduce the number of trapped air bubbles. The waiting period may be between zero to six hours. The solution may be slightly agitated prior to its being packed into a desired mold and frozen into a solid state. Other vitamins and minerals may be included in the formula to provide improved mineral and vitamin content. Such vitamins and minerals are the following by way of example only: vitamin C, B1, B2, B3, B6, folic acid (B9), B12, B5 (pantothenate), H (biotin), A, E, D3, K1, potassium iodide, cupric (sulfate anhydrous, picolinate, sulfate monohydrate, trioxide), selenomethionine, borax, zinc, calcium, magnesium, chromium, manganese, molybdenum, betacarotene, citrus bioflavonoids extract, iron, carotenes (e.g. lutein, lycopene), “near” Bvitamins (inositol, choline, PAPA), betaine hydrochloride, lecithin, and citrus bioflavinoids.

TABLE 7

| | Percentage | Percentage |
|---|---|---|
| | of Weight | of |
| | on total | Variance |
| Ingredient | Product | Allowable |
| Vitamin/Mineral | | |
| Pre Blend | | |
| Taurine USP | 54.053 | 75% |
| D- | 35.062 | |
| Glucuronolactone | | |
| Caffeine | 4.383 | |
| Anhydrous USP | | |
| Inositol | 3.562 | |
| Niacinamide | 1.400 | |
| Pyridoxine HCI | 0.498 | |
| Calcium | 0.441 | |
| Pantothenate | | |
| Vitamin B-12 | 0.397 | |
| (0.1%) | | |
| Riboflavin | 0.114 | |
| Vitamin B-12 | 0.397 | |
| (0.1%) | | |
| Riboflavin | 0.114 | |

The method of manufacture of a frozen confection including blending a starting material having a dried or powdered fruit and a dried material that has increased nutritional value to create a dry pre-blend; reconstituting the dry pre-blend with a liquid; blending the liquid and the pre-blend creating a slurry; allowing the slurry to settle to remove air bubbles; forming a slurry into desired format for frozen confection; and freezing the slurry.

The frozen confections may be formed into a wide variety of formats such as bars, push pops, formed, soft serve, hand held, tubs having various sizes, cakes (shaped), cones, and cups by way of example only.

The method of manufacture is simplified by the nature of the ingredients used. Specifically the use of dried products such as dehydrated fruit powder for the dried flavouring and dried protein such as whey, omega essential fatty acids, ginseng, guarana and taurine for the dried material with increased nutritional value, allows for a dry pre-blend that can be easily packaged and stored. The method of manufacture and the resulting confections however may utilize any dry flavouring such as a dried fruit powder, or dry cocoa powder by way of example only. The flavouring may also be wet, such as a wet fruit puree, by way of example only, that is mixed with the other dry ingredients such as the dry protein powder.

The packaged dry pre-blend can be easily and cost effectively shipped as there is no liquid and has a much longer shelf-life since there is no liquid that can promote bacteria growth or requires refrigeration. The dry pre-blend can be shipped to a production facility where reconstitution or re-hydration of the dry pre-blend can occur with the addition of water, liquid sugar or sweetener. Upon reconstitution the solution or slurry is sheer blended to mix all the ingredients. The solution is then allowed to settle so that any air bubbles that have been trapped in the solution dissipate. The solution may sit for a maximum of six hours depending on the formulation. Once the solution has settled, depending on the formulation, it may be moved to a flavour additive tank with mild agitation so as to incorporate the flavour. The solution may then be moved to the forming process for the desired format of the frozen confection and then frozen into a solid state. Once frozen the confection may be packaged and stored at −20° C.

Throughout this method or process, there is no need for pasteurization of the ingredients. All of the dry ingredients used in the pre-blend have been pasteurized prior to dehydrating. By not having to pasteurize the solution or slurry, the process is simplified, is more timely, more energy efficient, less costly, and less chance of human error and therefore contamination of the frozen confection.

Other variations and modifications of the invention are possible. All such modifications or variations are believed to be within the sphere and scope of the invention as defined by the claims appended hereto.

I claim:

1. A frozen confection comprising a starting material containing a wet or dried material having increased nutritional value and a wet or dry flavouring wherein the wet or dried material having increased nutritional value is between 0-75% of the weight of the frozen confection.

2. A frozen confection as claimed in claim 1 wherein the wet or dry flavouring is wet, dried or powdered fruit.

3. A frozen confection comprising a starting material containing a protein material and a wet or dry flavouring wherein the protein material is between 0-75% of the weight of the frozen confection.

4. A frozen confection as claimed in claim 3 wherein the wet or dry flavouring is wet dried or powdered fruit.

5. A frozen confection comprising a starting material containing wet or dried omega essential fatty acids and a wet or dry flavouring wherein the wet or dried omega essential fatty acids is between 0-95% of the weight of the frozen confection.

6. A frozen confection as claimed in claim 5 wherein the wet or dry flavouring is wet, dried or powdered fruit.

7. A frozen confection comprising a starting material containing wet or dried ginseng, wet or dried guarana and a wet or dry flavouring wherein the wet or dried ginseng is between 0-75% of the weight of the frozen confection, and the wet or dried guarana is between 0-75% of the weight of the frozen confection.

8. A frozen confection as claimed in claim 7 wherein the wet or dry flavouring is wet, powdered or dried fruit.

9. A frozen confection comprising a starting material containing wet or dried taurine and a wet or dry flavouring wherein the wet or dried taurine is between 0-75% of the weight of the frozen confection.

10. A frozen confection as claimed in claim 9 wherein the wet or dry flavouring is wet, dried or powdered fruit.

11. A frozen confection as claimed in claims 1, 3, 5, 7 or 9 wherein the wet flavouring is wet fruit puree.

12. A method of manufacturing a frozen confection, comprising:
(a) blending a starting material of dry flavouring and a dried material that has increased nutritional value to create a dry pre-blend;
(b) reconstituting the dry pre-blend with a liquid;
(c) blending the liquid and the pre-blend creating a slurry;
(d) allowing the slurry to settle to remove air bubbles;
(e) forming the slurry into a desired format for the frozen confection; and
(f) freezing the slurry to a frozen state.

13. A method of manufacturing a frozen confection as claimed in claim 12 wherein the powdered or dried flavouring is fruit.

14. A method of manufacturing a frozen confection as claimed in claim 12 wherein the dried material having increased nutritional value is protein substance 0-75% of the weight of the frozen confection.

15. A method of manufacturing a frozen confection as claimed in claim 12 wherein the dried material having increased nutritional value is dried omega essential fatty acids 0-95% of the weight of the frozen confection.

16. A method of manufacturing a frozen confection as claimed in claim 12 wherein the dried material having increased nutritional value is dried ginseng 0-75% of the weight of the frozen confection, and the dried guarana 0-75% of the weight of the frozen confection.

17. A method of manufacturing a frozen confection as claimed in claim 12 wherein the dried material having increased nutritional value is the dried taurine 0-75% of the weight of the frozen confection.

18. A method of manufacturing a frozen confection as claimed in claim 12 wherein the settling of the slurry occurs between zero and six hours.

19. A method of manufacturing a frozen confection as claimed in claim 12 further comprising agitating the slurry prior to forming the slurry into the desired format.

20. A method of manufacturing a frozen confection as claimed in claim 12 wherein the format of the frozen confection is a bar, push pop, formed, soft serve, hand held, tubs, cakes, cones, and cups.
